(19) United States
(12) Patent Application Publication
(10) Pub. No.: US 2018/0306689 A1
(43) Pub. Date: Oct. 25, 2018

(54) INFORMATION PROCESSING APPARATUS, INFORMATION PROCESSING METHOD, AND PROGRAM

(71) Applicant: SONY CORPORATION, TOKYO (JP)

(72) Inventors: TAKAAKI HIRANO, KANAGAWA (JP); KAZUHIRO HONGO, KANAGAWA (JP)

(21) Appl. No.: 15/768,967

(22) PCT Filed: Jul. 26, 2016
(86) PCT No.: PCT/JP2016/003457

§ 371 Date: Apr. 17, 2018

(30) Foreign Application Priority Data
Nov. 5, 2015 (JP) 2015-217461

(51) Int. Cl. G01N 3/02; G06F 17/50

(52) U.S. Cl. CPC G01N 3/02; G01N 2203/0066; G06F 17/5018

(57) ABSTRACT

[Object] To provide an information processing apparatus capable of predicting crack generation in a structure by ductile fracture in a short time, an information processing method, and a program. [Solving Means] An information processing apparatus includes a model acquisition unit and a crack prediction unit. The model acquisition unit acquires a structure model corresponding to a predetermined structure. The crack prediction unit predicts crack generation in the structure by calculating a differential equation including a term set at each position of the structure model and in proportion to a time differential of a crack variable that expresses presence or absence of a crack and a term set at each position of the structure model and in proportion to plastic dissipation energy that expresses energy dissipated at the time of plastic deformation by utilizing the crack variable. With this configuration, by calculating a differential equation using a crack variable that expresses presence or absence of a crack and plastic dissipation energy that expresses energy dissipated at the time of plastic deformation by utilizing the crack variable, crack generation by ductile fracture is predictable.

### TECHNICAL FIELD

The present technology relates to an information processing apparatus that can predict crack generation in a structure, an information processing method, and a program.

### BACKGROUND ART

In general, a variety of stresses such as a mechanical stress are applied to a variety of structures such as a semiconductor device in the course of manufacture or the like. In a case where the stress is applied to the structure, crack generation may occur inside the structure. In order to prevent the crack generation, there is used a technology that predicts in advance possible crack generation in the structure.

Patent Literature 1 discloses a technology that predicts possible crack generation in a structure. The technology disclosed in Patent Literature 1 predicts crack progress inside the structure by using an algorithm that utilizes a J integrated value and a stress intensity factor. However, the technology disclosed in Patent Literature 1 cannot predict crack generation across interfaces between a plurality of materials.

Patent Literature 2 discloses a technology that crack generation across interfaces between a plurality of materials is predictable. According to the technology disclosed in Patent Literature 2, an energy release rate is calculated by assumed crack progress inside a structure and the crack progress is predicted in the direction where the energy release rate is great.

### CITATION LIST

### Patent Literature

Patent Literature 1: Japanese Patent Application Laid-open No. 2010-160028

Patent Literature 2: Japanese Patent Application Laid-open No. 2011-204081

### DISCLOSURE OF INVENTION

### Technical Problem

In recent years, in accordance with a wide variety of structures such as a semiconductor device, a metal material and a resin material are widely used as a material of the structure. Accordingly, a technology that can accurately predict possible crack generation in the structure formed of a metal material and a resin material is required.

The technologies disclosed in Patent Literatures 1 and 2 can predict crack generation by brittle fracture but cannot predict crack generation by ductile fracture. A metal material and a resin material easily induce cracks by the ductile fracture. Accordingly, the technology disclosed in Patent Literature 2 is difficult to accurately predict possible crack generation in a structure formed of a metal material and a resin material.

In addition, in the technology disclosed in Patent Literature 2 using the energy release rate, it is necessary to calculate all energy release rates for crack progress in a variety of directions in order to predict the further crack progress. Accordingly, in the technology disclosed in Patent Literature 2, a calculation load becomes great and it is not possible to predict the crack in a short time.

The present technology is made in view of the above-mentioned circumstances, and it is an object of the present technology to provide an information processing apparatus capable of predicting crack generation in a structure by ductile fracture in a short time, an information processing method, and a program.

### Solution to Problem

In order to achieve the above-described object, an information processing apparatus according to an embodiment of the present technology includes a model acquisition unit and a crack prediction unit.

The model acquisition unit acquires a structure model corresponding to a predetermined structure.

The crack prediction unit predicts crack generation in the structure by calculating a differential equation including a term set at each position of the structure model and in proportion to a time differential of a crack variable that expresses presence or absence of a crack and a term set at each position of the structure model and in proportion to plastic dissipation energy that expresses energy dissipated at the time of plastic deformation by utilizing the crack variable.

With this configuration, by calculating a differential equation using a crack variable that expresses presence or absence of a crack and plastic dissipation energy that expresses energy dissipated at the time of plastic deformation by utilizing the crack variable, crack generation by ductile fracture is predictable. Thus, the crack generation in the structure formed of a material such as a metal material and a resin material that easily induces the ductile fracture is predictable in a short time.

The plastic dissipation energy may be set by utilizing an amount of integrating an equivalent stress with a small increment of equivalent plastic strain.

The plastic dissipation energy may be set by utilizing a product of a difference between an equivalent stress and a yield stress and equivalent plastic strain and is zero in a case where the equivalent stress is smaller than the yield stress.

With this configuration, the plastic dissipation energy can be set on the basis of a relationship between the equivalent stress and the equivalent plastic strain at each position of the structure model.

The differential equation may further include a diffusion term in proportion to a second order differential of a spatial coordinate.

With this configuration, the crack of the structure is more favorably predictable.

An information processing method according to an embodiment of the present technology acquires a structure model corresponding to a predetermined structure.

By calculating a differential equation including a term set at each position of the structure model and in proportion to a time differential of a crack variable that expresses presence or absence of a crack and a term set at each position of the structure model and in proportion to plastic dissipation energy that expresses energy dissipated at the time of plastic deformation by utilizing the crack variable, crack generation in the structure is predicted.

A program according to an embodiment of the present technology causes the information processing apparatus to predict crack generation in a structure by calculating a differential equation including a term set at each position of a structure model corresponding to a predetermined structure and in proportion to a time differential of a crack variable that expresses presence or absence of a crack and a term set at each position of the structure model and in proportion to plastic dissipation energy that expresses energy dissipated at the time of plastic deformation by utilizing the crack variable.

### Advantageous Effects of Invention

As described above, according to the present technology, an information processing apparatus that can predict crack generation in a structure, an information processing method, and a program can be provided.

It should be noted that the effects described here are not necessarily limitative and may be any of effects described in the present disclosure.

### BRIEF DESCRIPTION OF DRAWINGS

FIG. 1 is a flowchart showing a crack prediction method (information processing method) according to an embodiment of the present technology.

FIG. 2 are diagrams for illustrating a structure model generated by the crack prediction method.

FIG. 3 are diagrams showing examples of ways of expressing plastic dissipation energy set in the crack prediction method.

FIG. 4 is a diagram for illustrating loading conditions applied to the structure model.

FIG. 5 is a diagram for illustrating a distribution of the plastic dissipation energy of the structure model.

FIG. 6 is a diagram for illustrating a distribution of the crack variable of the structure model.

FIG. 7 is a diagram for illustrating the crack predicted in the structure model.

FIG. 8 is a diagram for illustrating a relationship between elastic modulus and the crack variable.

FIG. 9 is a diagram for illustrating a relationship between barrier energy and the crack variable.

FIG. 10 is a block diagram showing a construction of a crack prediction apparatus that can implement the crack prediction method.

### MODE(S) FOR CARRYING OUT THE INVENTION

Hereinafter, embodiments of the present technology will be described with reference to the drawings.

In the figures, the X axis, the Y axis, and the Z axis orthogonal each other are shown appropriately. The X axis, the Y axis, and the Z axis are common in all the figures.

[Overview of Crack Prediction Method]

An overview of a crack prediction method (information processing method) according to the present technology will be described. The crack prediction method according to the present technology predicts crack generation in a structure D by applying a concept of the Phase-Field model.

First, the crack prediction method based on the concept of the Phase-Field model associated with the present technology will be described.

(Crack Prediction Method by Concept of Phase-Field Model)

Energy F in the structure D is represented by the equation (1) by utilizing barrier energy f_{doub}, gradient energy f_{grad}, and elastic energy fₑₗₐₛₜ.

[Math. 1]

F=∫_{V}fdV=∫_{V}(f_{doub}+f_{grad}±fₑₗₐₛₜ)dV (1)

According to the concept of the Phase-Field model, a differential equation (2) can be derived from the equation (1).

$$\begin{matrix}[ Math . 2 ] & \\ \frac{1}{M} \frac{\partial φ}{\partial t} = ∇ ( ξ ∇ φ ) - ( \frac{\partial {f}_{doub}}{\partial φ} + \frac{\partial {f}_{elast}}{\partial φ} ) & ( 2 )\end{matrix}$$

The left side of the differential equation (2) is a product of the inverse of a mobility M and a time differential of a crack variable cp that expresses the presence or absence of generation of a crack.

The right side of the differential equation (2) includes a diffusion term ∇(ξ∇ø) of a second order differential of a spatial coordinate, a differential term of the barrier energy f_{doub}, and a differential term of the elastic energy fₑₗₐₛₜ. The differential equation (2) expresses a release rate of the elastic energy fₑₗₐₛₜ by the differential term of the elastic energy fₑₗₐₛₜ.

In order to calculate the differential equation (2), the crack variable φ is first set to each position of the structure D. Specifically, different crack variables φ are set to the positions having no cracks and on the positions having the cracks. For example, the crack variables φ of the positions having no cracks are set to “0”, and the crack variables φ of the positions having the cracks are set to “1”.

Then, as the calculation of the differential equation (2) proceeds, the position where the crack variable φ is “1” or more appears among the positions where the crack variable φ is set to “0” over time. According to the crack prediction method based on the concept of the Phase-Field model, it could be predicted that the crack is generated at the position where the crack variable φ is “1” or more after a predetermined time elapses.

According to the crack prediction method based on the concept of the Phase-Field model, by calculating the differential equation (2), it is possible to predict the crack in a short time. Also, according to the crack prediction method based on the concept of the Phase-Field model, as the crack generation across interfaces between a plurality of materials is predictable, the crack generation in the structure D including a plurality of materials is predictable. Furthermore, according to the crack prediction method based on the concept of the Phase-Field model, as the shape of the crack is not limited, a high versatility is provided.

According to the crack prediction method based on the concept of the Phase-Field model, the crack by brittle fracture is predictable by using the release rate of the elastic energy fₑₗₐₛₜ expressed by the differential term of the elastic energy fₑₗₐₛₜ included in the differential equation (2). However, according to the crack prediction method based on the concept of the Phase-Field model, the differential equation (2) does not include a term corresponding to a plastic deformation. Thus, the crack by a ductile fracture accompanied by a plastic deformation is unpredictable.

Accordingly, it is difficult to accurately predict, by using the crack prediction method utilizing the concept of the Phase-Field model, crack generation in the structure D formed of a material such as a metal material and a resin material that easily causes the ductile fracture.

In view of the above, the inventors of the present technology have found that the crack by the ductile fracture is predictable by applying the concept of the Phase-Field model and introducing a term including energy that dissipates mainly as heat upon the plastic deformation (hereinafter referred to as “plastic dissipation energy fₚₗₐₛₜ”) into the differential equation (2).

A crack prediction method according to the present technology by applying the concept of the Phase-Field model will be described below.

(Crack Prediction Method by Applying Concept of Phase-Field Model)

The crack prediction method according to the present technology by applying the concept of the Phase-Field model utilizes a differential equation (3) where the term of the plastic dissipation energy fₚₗₐₛₜ is introduced into the differential equation (2).

$$\begin{matrix}[ Math . 3 ] & \\ \frac{1}{M} \frac{1}{M} \frac{\partial φ}{\partial t} = ∇ ( ξ ∇ φ ) - ( \frac{\partial {f}_{doub}}{\partial φ} + \frac{\partial {f}_{elast}}{\partial φ} ) & ( 3 )\end{matrix}$$

In the differential equation (3), the plastic dissipation energy fₚₗₐₛₜ is different from the elastic energy fₑₗₐₛₜ and is not a differential term. This is because the plastic dissipation energy fₚₗₐₛₜ is accumulated over time while the elastic energy fₑₗₐₛₜ is released over time. In the differential equation (3), since the plastic dissipation energy fₚₗₐₛₜ is not represented by the differential term, the accumulation of the plastic dissipation energy fₚₗₐₛₜ can be expressed.

Thus, the differential equation (3) includes the differential term of the elastic energy fₑₗₐₛₜ that expresses the release rate of the elastic energy fₑₗₐₛₜ and the term of the plastic dissipation energy fₚₗₐₛₜ that expresses the accumulation calculating the differential equation (3), the crack is predictable by taking both of the brittle fracture and the ductile fracture into consideration.

Therefore, the present technology can accurately predict the crack generation in the structure D formed of a material such as a metal material and a resin material that easily induces the ductile fracture. Also, by the crack prediction method according to the present technology, similar to the crack prediction method based on the concept of the Phase-Field model, as the crack generation across interfaces between a plurality of materials is predictable, the crack generation in the structure D including a plurality of materials is predictable in a short time. Furthermore, according to the crack prediction method of the present technology, similar to the crack prediction method based on the concept of the Phase-Field model, as the shape of the crack is not limited, a high versatility is provided.

[Details of Crack Prediction Method]

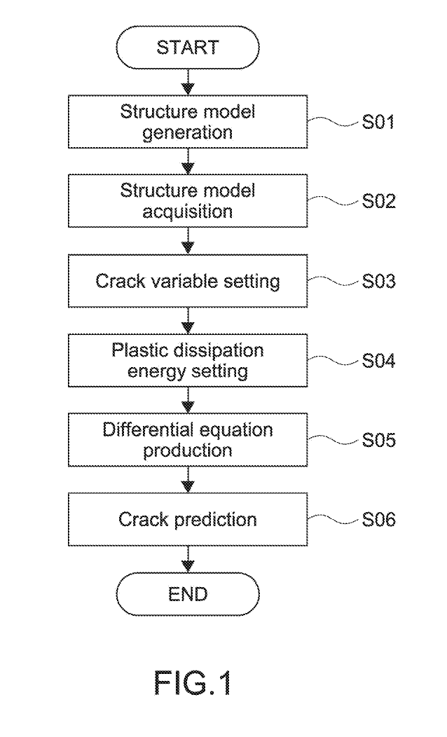

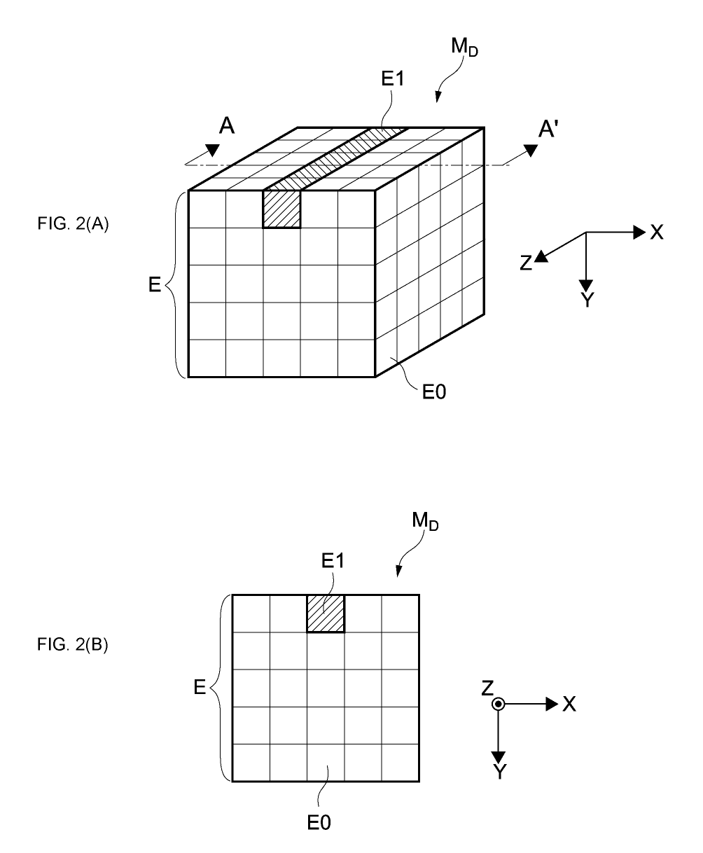

FIG. 1 is a flowchart showing a crack prediction method according to an embodiment of the present technology. FIGS. 2 to 9 are diagrams for illustrating respective steps of FIG. 1. Hereinafter, along with FIG. 1, appropriately referring to FIGS. 2 to 9, the crack prediction method according to this embodiment will be described.

(Model Generation Step S01)

In Step S01, a model (structure model) M_{D} regenerating the construction of the structure D is produced. By the structure model M_{D}, the construction of any structure D is reproducible. Examples of the structure D having the construction reproducible by the structure model M_{D} include a variety of devices, e.g., a semiconductor device.

As the crack prediction method, a finite element method (FEM) or a finite difference method (FDM) is usable. Also, an implicit method or an explicit method is usable.

The finite element method is applicable to any shape, with which a high versatility is provided. By the finite difference method, it is easy to calculate in parallel, which advantageously results in fast calculation. The implicit method provides an advantage that a time step is increased.

According to this embodiment, the finite element method is used, and the structure model M_{D} is therefore constituted of a plurality of elements E.

FIG. 2 are diagrams illustrating the structure model M_{D} generated in Step S01. FIG. 2 (A) is a perspective view of the structure model M_{D}, and FIG. 2 (B) is a cross-sectional view of the structure model M_{D} taken along the A-A′ line of FIG. 2 (A). The structure D having the construction regenerated by the structure model M_{D} of FIG. 2 roughly has a shape of a cube and an initial crack extending in the Z axis direction is formed at the center of an upper face.

In this case, in the structure model M_{D}, five elements E arrayed in the Z axis direction at the center in the X axis direction on an upper face in the Y axis direction are elements E1 having cracks and the other elements E are elements E0 having no cracks. In FIG. 2, the elements E1 having cracks are shown by hatched lines and the elements E0 having no cracks are shown by white. Note that the elements E having free spaces, e.g., cavities, are preferably handled similar to the elements E1 having cracks.

In the following description, the structure model M_{D} of FIG. 2 is illustrated. It should be appreciated that other structure models M_{D} can be similarly handled.

Note that, for example, in a case where the structure model M_{D} is prepared in advance, Step S01 may be omitted.

(Model Acquisition Step S02)

In Step S02, the structure model M_{D} generated in Step S01 is acquired.

Note that in a case where Step S01 is not performed, the structure model M_{D} can be acquired from external devices and the like in Step S02.

(Crack Variable Setting Step S03)

In Step S03, a crack variable φ that expresses the presence or absence of a crack on each element E of the structure model M_{D} acquired in Step S02 is set.

Specifically, different crack variables φ are set to the elements E0 having no cracks and the elements E1 having cracks of the structure model M_{D}. More specifically, the crack variables φ of the elements E0 having no cracks are set to “m” and the crack variables φ of the elements E1 having cracks are set to “n” different from “m”. Either of “m” and “n” may be greater than the other.

As an example, the crack variables φ of the elements E0 having no cracks are set to “0” and the crack variables φ of the elements E1 having cracks are set to “1”.

Note that, for example, in a case where the crack variable φ is set for the structure model M_{D} in advance, Step S03 may be omitted.

(Plastic Dissipation Energy Setting Step S04)

In Step S04, the plastic dissipation energy fₚₗₐₛₜ to each element E of the structure model M_{D} acquired in Step S02 is set.

Note that since no plastic deformation is generated in the elements E1 already having cracks, the plastic dissipation energy fₚₗₐₛₜ is not accumulated. Thus, the plastic dissipation energy fₚₗₐₛₜ of the elements E1 is set to “0”.

The plastic dissipation energy fₚₗₐₛₜ of the elements E0 having no cracks is set on the basis of a relationship between an equivalent stress σ and an equivalent plastic strain εₚ empirically determined corresponding to the materials of the elements E0. Since the equivalent plastic strain εₚ depends on the crack variable φ, the plastic dissipation energy fₚₗₐₛₜ is represented as a function of the crack variable φ.

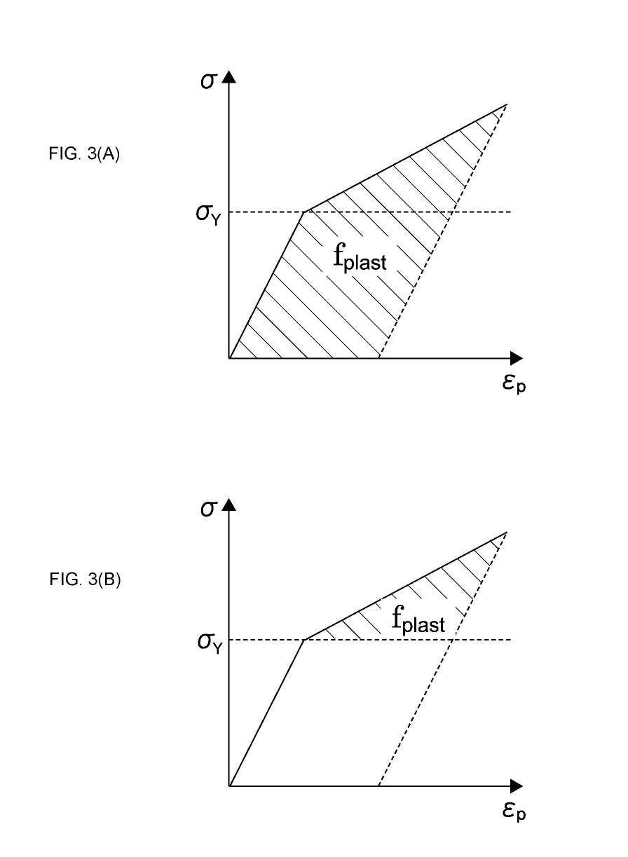

FIG. 3 are diagrams showing examples of ways of expressing the plastic dissipation energy fₚₗₐₛₜ of the elements E0 set in Step S04. FIG. 3 show examples of equivalent stress-equivalent plastic strain diagrams of the material of the structure D. In each of FIG. 3, the vertical axis represents the equivalent stress σ and the horizontal axis represents the equivalent plastic strain εₚ. In FIG. 3, a yield stress σ_{Y} is also shown.

The material showing the equivalent stress-equivalent plastic strain diagrams of FIG. 3 causes an elastic deformation in a region where the equivalent stress σ is less than the yield stress σ_{Y} and causes the plastic deformation in a region where the equivalent stress σ is the yield stress σ_{Y} or more. The plastic dissipation energy fₚₗₐₛₜ refers to energy that is dissipated mainly as thermal energy due to the plastic deformation of the material when the equivalent stress σ is the yield stress σ_{Y} or more.

The plastic dissipation energy fₚₗₐₛₜ can be defined by areas of the regions shown by hatched lines in FIG. 3 (A) and FIG. 3 (B), for example.

The area of the region shown by the hatched lines in FIG. 3 (A) can be calculated using the amount acquired by integrating the equivalent stress σ with a small increment of the equivalent plastic strain εₚ, e.g., using the equation (4).

[Math. 4]

fₚₗₐₛₜ=∫σdεₚ (4)

In addition, the area of the region shown by the hatched lines in FIG. 3 (B) can be calculated using the product of the difference between the equivalent stress σ and the yield stress σ_{Y} and the equivalent plastic strain εₚ, e.g., using the equation (5).

[Math. 5]

fₚₗₐₛₜ=½(σ−σ_{Y})εₚ (5)

Note that the plastic dissipation energy fₚₗₐₛₜ is zero in a case where the equivalent stress σ is smaller than the yield stress σ_{Y} in the equation (5).

The ways of expressing the plastic dissipation energy fₚₗₐₛₜ can be used properly so as to accurately predict the crack generation depending on the material of the structure D, a physical phenomenon, and the like. Note that the functions for expressing the plastic dissipation energy fₚₗₐₛₜ are not limited to the equation (4) and the equation (5) and can be appropriately prepared on the bases of the relationship between the equivalent stress σ and the equivalent plastic strain εₚ.

Note that, for example, in a case where the plastic dissipation energy fₚₗₐₛₜ is set to the structure model M_{D} in advance, Step S04 may be omitted.

(Differential Equation Production Step S05)

In Step S05, a differential equation is produced by utilizing the crack variables φ set in Step S03 and the plastic dissipation energy fₚₗₐₛₜ set in Step S04.

An example of the differential equation produced in Step S05 includes the differential equation (3). Alternatively, in Step S05, a differential equation (6) may be produced by modifying the differential equation (3).

$$\begin{matrix}[ Math . 6 ] & \\ \frac{1}{M} \frac{\partial φ}{\partial t} = ∇ ( ξ ∇ φ ) - ( {w}_{doub} \frac{\partial {f}_{doub}}{\partial φ} + {w}_{elast} \frac{\partial {f}_{elast}}{\partial φ} + {w}_{plast} {f}_{plast} ) & ( 6 )\end{matrix}$$

A fitting constant w_{doub} for the differential term of the barrier energy f_{doub}, a fitting constant wₑₗₐₛₜ for the differential term of the elastic energy fₑₗₐₛₜ, and a fitting constant wₚₗₐₛₜ for the term of the plastic dissipation energy fₚₗₐₛₜ are introduced into the differential equation (6). Thus, it is possible to optimize weighting of each of the differential term of the barrier energy f_{doub}, the differential term of the elastic energy fₑₗₐₛₜ, and the term of the plastic dissipation energy fₚₗₐₛₜ depending on the constitution of the structure D and the like. As a result, the crack generation in the structure D is more accurately predictable.

Note that, for example, in a case where the differential equation is produced in advance, Step S05 may be omitted.

(Crack Prediction Step S06)

In Step S06, the crack generation in the structure D is predicted by calculating the differential equation produced in Step S05.

Note that in a case where Step S05 is not performed, the crack generation in the structure D is predicted by calculating the differential equation acquired from external devices and the like in Step S06.

Upon the calculation of the differential equation, in order to reproduce the stress applied to the structure D, stress analysis is first performed by applying loading conditions to the structure model M_{D}.

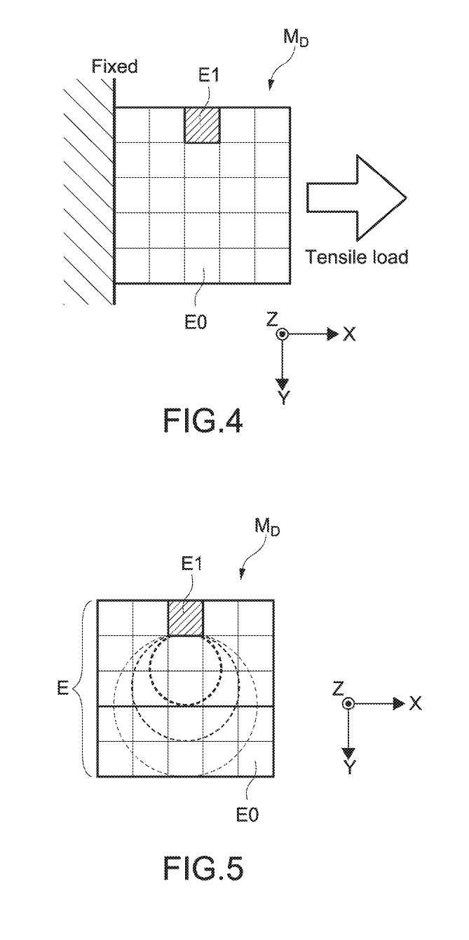

FIG. 4 shows an example of the loading conditions applied to the structure model M_{D}. In the example shown in FIG. 4, while a left side plane of the structure model M_{D} in the X axis direction is fixed (restrained), a tensile load is applied to a right side plane of the structure model M_{D} in the X axis.

Thus, by calculating the differential equation under the loading conditions, a change in the crack variable φ of each element E0 associated with the time elapsed is provided.

FIG. 5 shows a distribution of the plastic dissipation energy fₚₗₐₛₜ at a certain time in a case where the loading conditions are applied to the structure model M_{D} as shown in FIG. 4. FIG. 5 shows a constant-energy surface having the equal plastic dissipation energy fₚₗₐₛₜ. In the structure model M_{D}, the constant-energy surface is expanded in an arc shape. The nearer the lower plane of the element E1 located at a tip of the crack in the Y axis direction is, the greater the plastic dissipation energy fₚₗₐₛₜ is.

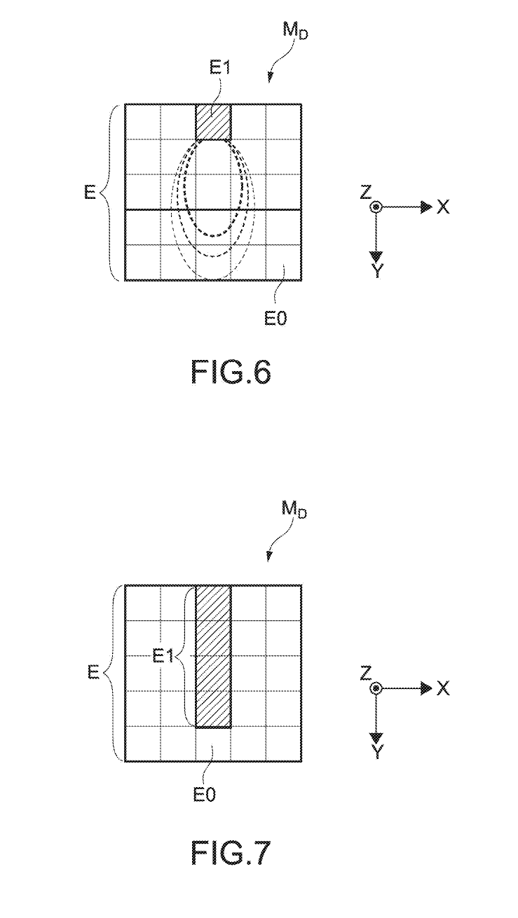

FIG. 6 shows a distribution of the crack variable φ at a certain time in a case where the loading conditions are applied to the structure model M_{D} as shown in FIG. 4. FIG. 6 shows a constant-crack variable surface having the equal crack variable φ. In the structure model M_{D}, the constant-crack variable surface is expanded in an elliptic arc extending from the lower plane of the element E1 located at a tip of the crack to the lower position in the Y axis direction. The more inner the constant-crack variable surface is, the greater the crack variable φ is.

In Step S06, the crack generation is predicted at the element E0 where the crack variable φ is “1” or more after a predetermined time elapses. For example, in a case where three elements E0 at the lower side of the element E1 in the Y axis direction have the crack variable φ of “1” or more, the cracks are considered to be generated in the three elements E0 and the three elements E0 are changed to the elements E1 as shown in FIG. 7.

In addition, in the course of proceeding the calculation of the differential equation, it is desirable that the plastic dissipation energy fₚₗₐₛₜ of the element E0 that changes to have the crack variable φ of “1” or more be successively changed to “0”. As a result, while the status of the crack of the structure model M_{D} is successively updated, the calculation of the differential equation can be performed. Thus, the crack generation can be more accurately predicted.

As described above, in Step S06, by calculating the differential equation, the distribution of the elements E1 having the cracks in the structure model M_{D} after a predetermined time elapses is provided. Then, the crack generation in the structure D can be predicted on the basis of the distribution of the elements E1 having the crack(s) in the structure model M_{D}.

[Alternative Embodiment of Differential Equation]

The differential equation produced in Step S05 is not limited to the differential equations (3) and (6) produced on the basis of the concept of the Phase-Field model and can be appropriately changed. Hereinafter, alternative embodiments of the differential equations usable in the present technology.

1. Customization Depending on Material of Structure D

The differential equations (3) and (6) produced on the basis of the concept of the Phase-Field model include a diffusion term in proportion to a second order differential of a spatial coordinate and a differential term of the elastic energy fₑₗₐₛₜ, and is therefore applicable to the structure D formed of a wide range of materials. Thus the differential equations (3) and (6) provide a high versatility.

On the other hand, depending on the material of the structure D, the differential equations (3) and (6) include unnecessary terms. Accordingly, the differential equation is customized, for example, by excluding unnecessary terms depending on the material of the structure D in Step S05. As a result, the crack generation in the structure D is accurately predictable in a short time.

The crack prediction method according to the present technology can desirably predict the crack generation in the structure D formed of a material such as a metal material and a resin material that easily causes the ductile fracture. Therefore, the differential equation produced in Step S05 may include at least the term in proportion to the time differential of the crack variable φ and the term in proportion to the plastic dissipation energy fₚₗₐₛₜ set in Step S04.

Hereinafter, examples of the materials of the structure D are described and the differential equations customized depending on the materials are illustrated. Note that the materials of the structure D are not limited thereto and may be any materials. Also, the differential equations corresponding to the materials are not limited thereto and can be arbitrarily customized.

(a) Material that Less Causes Brittle Fracture

In a case where the material of the structure D less causes the brittle fracture, a differential equation (7) that excludes the terms other than the term of the plastic dissipation energy fₚₗₐₛₜ and takes only the ductile fracture into consideration can be used, for example.

$$\begin{matrix}[ Math . 7 ] & \\ \frac{\partial φ}{\partial t} = - {f}_{plast} & ( 7 )\end{matrix}$$

The differential equation (7) includes only the term of the time differential of the crack variable φ and the term of the plastic dissipation energy fₚₗₐₛₜ. Note that the term of the plastic dissipation energy fₚₗₐₛₜ may include the fitting constant wₚₗₐₛₜ.

Thus, by using the differential equation (7) simplified by excluding the terms other than the term of the plastic dissipation energy fₚₗₐₛₜ, a calculation load can be significantly reduced.

(b) Material Having Elastic Modulus a Anisotropy

In a case where the material of the structure D has elastic modulus A anisotropy, a differential equation (8) taking the elastic modulus A anisotropy into consideration can be used, for example.

$$\begin{matrix}[ Math . 8 ] & \\ \frac{1}{M} \frac{\partial φ}{\partial t} = - \frac{δ {F}_{sys}}{δφ} - {f}_{plast} & ( 8 )\end{matrix}$$

In the differential equation (8), the system energy F_{sys} is represented by the equation (9).

[Math. 9]

F_{sys}=∫_{V}(f_{grad}+fₑₗₐₛₜ)dV (9)

In the equation (9), the gradient energy f_{grad} is represented by the equation (10) and the elastic energy fₑₗₐₛₜ is represented by the equation (11).

[Math. 10]

f_{grad}=½κ|∇ϕ|²; (10)

In the equation (10), κ denotes the material constant.

$$\begin{matrix}[ Math . 11 ] & \\ {f}_{elast} = {\sum }_{ijkl} {A}_{ijkl} {ɛ}_{ij} {ɛ}_{kl} & ( 11 )\end{matrix}$$

In the equation (11), ε denotes the normal strain.

In the equation (11), since the elastic modulus A is handled as tensor, the elastic modulus A anisotropy can be appropriately reflected on the prediction result. Thus, by calculating the differential equation (8), the crack generation in the structure D formed of the material having the elastic modulus A anisotropy can be accurately predicted.

Note that in a case where the material of the structure D has elastic modulus A isotropy, the elastic energy fₑₗₐₛₜ can be represented by the equation (12) instead of the equation (11).

$$\begin{matrix} [ Math . 12 ] & \\ {f}_{elast} = \frac{1}{2} \frac{Av}{( 1 + v ) ( 1 - 2 v )} {( {ɛ}_{xx} + {ɛ}_{yy} + {ɛ}_{zz} )}^{2} + \frac{1}{2} \frac{Av}{( 1 + v )} ( {ɛ}_{xx}^{2} + {ɛ}_{yy}^{2} + {ɛ}_{zz}^{2} + \frac{1}{2} {γ}_{xy}^{2} + \frac{1}{2} {γ}_{yz}^{2} + \frac{1}{2} {γ}_{zx}^{2} ) & ( 12 )\end{matrix}$$

In the equation (12), ν denotes the Poisson's ratio and γ denotes the shear strain.

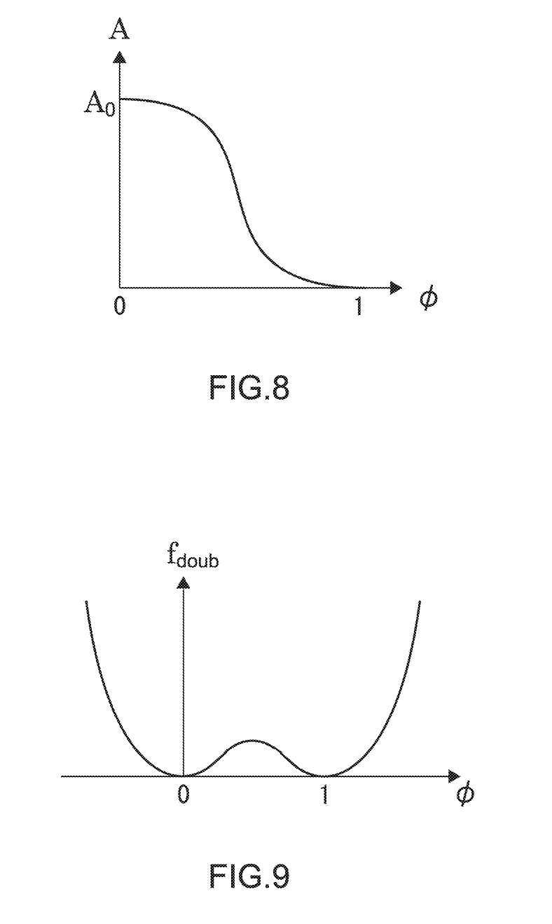

In addition, the elastic modulus A in the equation (12) can be the function dependent on the crack variable φ shown in FIG. 8, for example. In the function shown in FIG. 8, as the crack variable φ is increased, the elastic modulus A is decreased. In other words, the function shown in FIG. 8 can express that the elasticity of the material forming the structure D is decreased with the accumulation of the plastic dissipation energy fₚₗₐₛₜ.

(c) Material Having Toughness Value Anisotropy

In a case where the material forming the structure D has toughness value anisotropy, the differential equation (13) where the factor of the diffusion term is the function of the gradient of the crack variable φ, i.e., the function in a normal direction of the interface, can be used, for example.

$$\begin{matrix}[ Math . 13 ] & \\ \frac{1}{M} \frac{\partial φ}{\partial t} = - \frac{δ {F}_{sys}}{δφ} - {f}_{plast} & ( 13 )\end{matrix}$$

In the differential equation (13), the system energy F₅₅ is represented by the equation (14).

[Math. 14]

F_{sys}=∫_{V}(f_{grad}+fₑₗₐₛₜ)dV (14)

In the equation (14), the gradient energy f_{grad} is represented by the equation (15) and the elastic energy fₑₗₐₛₜ is represented by the equation (17).

[Math. 15]

f_{grad}=½κ|∇ϕ|² (15)

In the equation (15), κ denotes the material constant and is represented by the equation (16).

[Math. 16]

κ=a(∇ϕ/|∇ϕ|) (16)

In the equation (16), a denotes the anisotropy function.

$$\begin{matrix} [ Math . 17 ] & \\ {f}_{elast} = \frac{1}{2} \frac{Av}{( 1 + v ) ( 1 - 2 v )} {( {ɛ}_{xx} + {ɛ}_{yy} + {ɛ}_{zz} )}^{2} + \frac{1}{2} \frac{Av}{( 1 + v )} ( {ɛ}_{xx}^{2} + {ɛ}_{yy}^{2} + {ɛ}_{zz}^{2} + \frac{1}{2} {γ}_{xy}^{2} + \frac{1}{2} {γ}_{yz}^{2} + \frac{1}{2} {γ}_{zx}^{2} ) & ( 17 )\end{matrix}$$

In the equation (17), ν denotes the Poisson's ratio and γ denotes the shear strain.

By using the equation (16), the diffusion factor can be changed on the basis of the directions of the interfaces and ease of crack progress can be changed in accordance with the directions. Accordingly, the toughness value anisotropy can be appropriately reflected on the prediction result. Thus, by calculating the differential equation (13), the crack generation in the structure D formed of the material having the toughness value anisotropy can be accurately predicted.

(d) Material where Brittle Fracture and Ductile Fracture Simultaneously Progress

In a case where the structure D is formed of a material where the brittle fracture and the ductile fracture simultaneously progress, cracks may be generated in the structure D caused by a combination of the brittle fracture and the ductile fracture. In order to predict the crack generation caused by the combination of the brittle fracture and the ductile fracture, the differential equation (18) may be used, for example.

$$\begin{matrix}[ Math . 18 ] & \\ \frac{1}{M} \frac{\partial φ}{\partial t} = - \frac{δ {F}_{sys}}{δφ} - {f}_{plast} & ( 18 )\end{matrix}$$

In the differential equation (18), the system energy F₅₅ is represented by the equation (19).

[Math. 19]

F_{sys}=∫_{V}(f_{grad}+fₑₗₐₛₜ)dV (19)

In the equation (19), the gradient energy f_{grad} is represented by the equation (20) and the elastic energy fₑₗₐₛₜ is represented by the equation (21).

[Math. 20]

f_{grad}=½κ|∇ϕ|² (20)

In the equation (20), κ denotes the material constant.

$$\begin{matrix} [ Math . 21 ] & \\ {f}_{elast} = \frac{1}{2} \frac{Av}{( 1 + v ) ( 1 - 2 v )} {( {ɛ}_{xx} + {ɛ}_{yy} + {ɛ}_{zz} )}^{2} + \frac{1}{2} \frac{Av}{( 1 + v )} ( {ɛ}_{xx}^{2} + {ɛ}_{yy}^{2} + {ɛ}_{zz}^{2} + \frac{1}{2} {γ}_{xy}^{2} + \frac{1}{2} {γ}_{yz}^{2} + \frac{1}{2} {γ}_{zx}^{2} ) & ( 21 )\end{matrix}$$

In the equation (21), ν denotes the Poisson's ratio, ε denotes the normal strain, and γ denotes the shear strain.

The differential equation (18) can analyze the brittle fracture by using the release rate of the elastic energy fₑₗₐₛₜ and can also analyze the ductile fracture by using the accumulation of the plastic dissipation energy fₚₗₐₛₜ. Accordingly, by calculating the differential equation (18), the crack generation in the structure D caused by the combination of the brittle fracture and the ductile fracture is predictable.

2. Stabilization of Interfaces

In order to favorably express the cracks in the structure D, the interfaces between the elements E0 having no cracks and the elements E1 having cracks of the structure model M_{D} are preferably stabilized. Specifically, it is preferable that the crack variables φ of the elements E0 having no cracks have values of around “0”, the crack variables φ of the elements E1 having cracks have value of around “1”, and any crack variable of the elements E desirably does not have the middle value between “0” and “1”.

In order to stabilize the interfaces between the elements E0 having no cracks and the elements E1 having cracks of the structure model M_{D}, the differential equation (22) can be used, for example.

$$\begin{matrix}[ Math . 22 ] & \\ \frac{1}{M} \frac{\partial φ}{\partial t} = - \frac{δ {F}_{sys}}{δφ} - {f}_{plast} & ( 22 )\end{matrix}$$

In the differential equation (22), the system energy F_{sys} is represented by the equation (23).

[Math. 23]

F_{sys}=∫_{V}(f_{doub}+fₑₗₐₛₜ)dV (23)

In the equation (23), the barrier energy f_{doub} is represented by the equation (24) and the elastic energy fₑₗₐₛₜ is represented by the equation (25).

[Math. 24]

f_{grad}=½κ|∇ϕ|² (24)

In the equation (24), κ denotes the material constant.

[Math. 25]

f_{doub}=e_{doub}ϕ²(1−ϕ)² (25)

In the equation (25), e_{doub} denotes an energy barrier.

The equation (25) is a double well function as shown in FIG. 9. Specifically, the barrier energy f_{doub} has the minimum values at the crack variables φ=0 and 1. Accordingly, the crack variables φ easily have the values around “0” or “1” and less easily have the middle value between “0” and “1”. Thus, the interfaces between the elements E0 having no cracks and the elements E1 having cracks of the structure model M_{D} are stabilized.

In addition, the equation (25) can express a resistance to the crack generation of the material forming the structure D by the energy barrier e_{doub}. Specifically, the energy barrier e_{doub} is increased in a case where the cracks are easily generated and the energy barrier e_{doub} is decreased in a case where the cracks are difficult to be generated.

[Crack Prediction Apparatus 10]

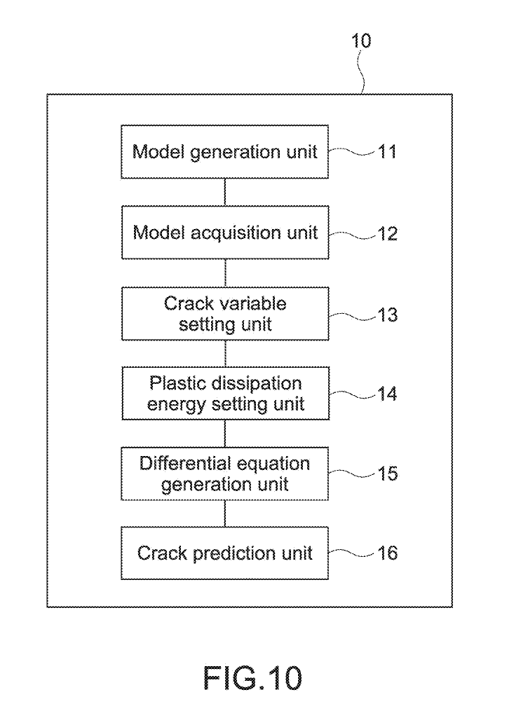

FIG. 10 is a block diagram showing a construction of a crack prediction apparatus (information processing apparatus) 10 that can implement the crack prediction method according to the above-described embodiments. The crack prediction apparatus 10 includes a model generation unit 11, a model acquisition unit 12, a crack variable setting unit 13, a plastic dissipation energy setting unit 14, a differential equation generation unit 15, and a crack prediction unit 16. The respective units of the crack prediction apparatus 10 are configured to be capable of executing the steps of FIG. 1 when the crack prediction apparatus 10 executes a predetermined program.

Specifically, the model generation unit 11 is configured to be capable of executing the model generation Step S01.

The model acquisition unit 12 is configured to be capable of executing the model acquisition Step S02.

The crack variable setting unit 13 is configured to be capable of executing the crack variable set Step S03.

The plastic dissipation energy setting unit 14 is configured to be capable of executing the plastic dissipation energy setting Step S04.

The differential equation generation unit 15 is configured to be capable of executing can execute the differential equation generation Step S05.

The crack prediction unit 16 is configured to be capable of executing the crack prediction Step S06.

Note that the crack prediction apparatus 10 may include at least the model acquisition unit 12 and the crack prediction unit 16. In other words, if Steps S01, S03 to S05 are not executed, the crack prediction apparatus 10 may not include the model generation unit 11, the crack variable setting unit 13, the plastic dissipation energy setting unit 14, and the differential equation generation unit 15.

In addition, the crack prediction apparatus 10 may include the constructions other than the above, as necessary.

### Other Embodiments

The embodiments of the present technology are described above and the present technology is not limited to the above-described embodiments. Various modifications and alterations may be available without departing from the spirit and scope of the present technology.

For example, according to the embodiments, the element E of the structure model M_{D} is a primary element, but may be a secondary element, as necessary. In this case, as a distribution of the crack variables φ within the respective elements M of the structure model M_{D} can be taken into account, the crack generation in the structure D is more accurately predictable.

The present technology may also have the following structures.

(1) An information processing apparatus, including:

a model acquisition unit that acquires a structure model corresponding to a predetermined structure; and

a crack prediction unit that predicts crack generation in the structure by calculating a differential equation including a term set at each position of the structure model and in proportion to a time differential of a crack variable that expresses presence or absence of a crack and a term set at each position of the structure model and in proportion to plastic dissipation energy that expresses energy dissipated at the time of plastic deformation by utilizing the crack variable.

(2) An information processing apparatus according to (1), in which

the plastic dissipation energy is set by utilizing an amount of integrating an equivalent stress with a small increment of equivalent plastic strain.

(3) An information processing apparatus according to (1), in which

the plastic dissipation energy is set by utilizing a product of a difference between an equivalent stress and a yield stress and equivalent plastic strain and is zero in a case where the equivalent stress is smaller than the yield stress.

(4) An information processing apparatus according to any one of (1) to (3), in which

the differential equation further includes a diffusion term in proportion to a second order differential of a spatial coordinate.

(5) An information processing method, including:

acquiring a structure model corresponding to a predetermined structure; and

predicting crack generation in the structure by calculating a differential equation including a term set at each position of the structure model and in proportion to a time differential of a crack variable that expresses presence or absence of a crack and a term set at each position of the structure model and in proportion to plastic dissipation energy that expresses energy dissipated at the time of plastic deformation by utilizing the crack variable.

(6) A program executable by an information processing apparatus, the program causing the information processing apparatus to:

predict crack generation in a structure by calculating a differential equation including a term set at each position of a structure model corresponding to a predetermined structure and in proportion to a time differential of a crack variable that expresses presence or absence of a crack and a term set at each position of the structure model and in proportion to plastic dissipation energy that expresses energy dissipated at the time of plastic deformation by utilizing the crack variable.

### REFERENCE SIGNS LIST

10 crack prediction apparatus (information processing apparatus)
11 model generation unit
12 model acquisition unit
13 crack variable setting unit
14 plastic dissipation energy setting unit
15 differential equation generation unit
16 crack prediction unit
M_{D} structure model
E, E0, E1 element

1. An information processing apparatus, comprising:
a model acquisition unit that acquires a structure model corresponding to a predetermined structure; and
a crack prediction unit that predicts crack generation in the structure by calculating a differential equation including a term set at each position of the structure model and in proportion to a time differential of a crack variable that expresses presence or absence of a crack and a term set at each position of the structure model and in proportion to plastic dissipation energy that expresses energy dissipated at the time of plastic deformation by utilizing the crack variable.

2. An information processing apparatus according to claim 1, wherein
the plastic dissipation energy is set by utilizing an amount of integrating an equivalent stress with a small increment of equivalent plastic strain.

3. An information processing apparatus according to claim 1, wherein
the plastic dissipation energy is set by utilizing a product of a difference between an equivalent stress and a yield stress and equivalent plastic strain and is zero in a case where the equivalent stress is smaller than the yield stress.

4. An information processing apparatus according to claim 1, wherein
the differential equation further includes a diffusion term in proportion to a second order differential of a spatial coordinate.

5. An information processing method, comprising:
acquiring a structure model corresponding to a predetermined structure; and
predicting crack generation in the structure by calculating a differential equation including a term set at each position of the structure model and in proportion to a time differential of a crack variable that expresses presence or absence of a crack and a term set at each position of the structure model and in proportion to plastic dissipation energy that expresses energy dissipated at the time of plastic deformation by utilizing the crack variable.

6. A program executable by an information processing apparatus, the program causing the information processing apparatus to:
predict crack generation in a structure by calculating a differential equation including a term set at each position of a structure model corresponding to a predetermined structure and in proportion to a time differential of a crack variable that expresses presence or absence of a crack and a term set at each position of the structure model and in proportion to plastic dissipation energy that expresses energy dissipated at the time of plastic deformation by utilizing the crack variable.
